(19) United States
(12) Patent Application Publication
(10) Pub. No.: US 2026/0244177 A1
(43) Pub. Date: Aug. 20, 2026

(54) POWER CONTROL SYSTEM

(71) Applicant: DENSO CORPORATION, Kariya-city (JP)

(72) Inventors: Manahiro MORITA, Kariya-city (JP); Tomoya TOKUNAGA, Kariya-city (JP); Yukihiro YAMAKAWA, Kariya-city (JP)

(21) Appl. No.: 19/539,114

(22) Filed: Feb. 13, 2026

(30) Foreign Application Priority Data
Feb. 18, 2025 (JP) 2025-024300

(51) Int. Cl. G05B 15/02; G06F 1/26; G06F 1/28; G06F 1/3203; G06F 1/3287

(52) U.S. Cl. CPC G05B 15/02; G06F 1/26; G06F 1/263; G06F 1/266; G06F 1/28; G06F 1/3203; G06F 1/3287

(57) ABSTRACT

A power control system for an electronic control unit includes a plurality of electronic control devices configured to receive power from a battery. At least one of the plurality of electronic control devices corresponds to a switch control device that controls an on/off state of a semiconductor switch for supplying the power from the battery to other electronic control devices. The switch control device includes a control logic that enables redundant control of the semiconductor switch by designating one of the other electronic control devices as a redundant control device, and also allows invalidation of the redundant control.

### CROSS REFERENCE TO RELATED APPLICATION

This application is based on Japanese Patent Application No. 2025-024300 filed on February 18, 2025, the disclosure of which is incorporated herein by reference.

### TECHNICAL FIELD

The present disclosure relates to a system for controlling the supply of power among a plurality of electronic control units mounted on a mobility.

### BACKGROUND

A related art discloses a system for supplying power to a plurality of high-voltage electronic devices, in which control is performed from the perspective of interlock.

### SUMMARY

According to an aspect of the present disclosure, a power control system for an electronic control unit, mounted on a mobile body, is provided. The power control system includes a plurality of electronic control devices configured to receive power from a battery. At least one of the plurality of electronic control devices may be a switch control device that controls on/off state of a semiconductor switch for supplying the power from the battery to other electronic control devices. The switch control device may include a control logic that enables redundant control of the semiconductor switch by designating one of the other electronic control devices as a redundant control device, and also allow invalidation of the redundant control.

### BRIEF DESCRIPTION OF DRAWINGS

Objects, features and advantages of the present disclosure will become more apparent from the following detailed description made with reference to the accompanying drawings. In the drawings:

FIG. 1 is a functional block diagram in the first embodiment, mainly illustrating the IDL control signal output from the IDL of the first battery ECU to the upstream power distribution unit and each zone ECU;

FIG. 2 is a functional block diagram mainly illustrating the wiring of power lines and communication lines;

FIG. 3 is a functional block diagram showing the internal configuration of the mobility computer;

FIG. 4 is a functional block diagram showing the internal configuration of the first battery ECU;

FIG. 5 is a functional block diagram showing the internal configuration of the upstream power distribution unit X;

FIG. 6 is a functional block diagram showing the configuration of the zone ECU;

FIG. 7 is a functional block diagram showing the configuration of the slave ECU;

FIG. 8A is a diagram showing the specific configuration of the zone logic unit in the zone ECU;

FIG. 8B is a truth table of the first zone logic unit;

FIG. 9 is a functional block diagram in the second embodiment, mainly illustrating the IDL control signal output from the IDL of the first battery ECU to the upstream power distribution unit and each zone ECU;

FIG. 10 is a functional block diagram in the third embodiment, mainly illustrating the IDL control signal output from the IDL of the first battery ECU to the upstream power distribution unit and each zone ECU;

FIG. 11 is a functional block diagram in the fourth embodiment, mainly illustrating the IDL control signal output from the IDLs of the first and second battery ECUs to the upstream power distribution unit and each zone ECU;

FIG. 12 is a functional block diagram in the fifth embodiment, mainly illustrating the IDL control signal output from the IDLs of the first and second battery ECUs and the IDL of the mobility computer to the upstream power distribution unit and each zone ECU;

FIG. 13 is a functional block diagram in the sixth embodiment, mainly illustrating the IDL control signal output from the IDLs of the first and second battery ECUs and the IDL of the mobility computer to the upstream power distribution unit and each zone ECU;

FIG. 14 is a functional block diagram in the seventh embodiment, mainly illustrating the IDL control signal output from the IDLs of the first and second battery ECUs and the IDL of the mobility computer to the upstream power distribution unit and each zone ECU; and

FIG. 15 is a diagram showing a configuration in the eighth embodiment in which interlock control is mutually performed between the upstream power distribution unit and the zone ECU.

### DETAILED DESCRIPTION

A vehicle, which is a mobile body, is equipped with numerous ECUs (Electronic Control Units) as electronic control devices. Power from the battery is supplied to these multiple ECUs via various power supply systems. Furthermore, not all ECUs are always operating; there are cases where the power supply to ECUs that do not require operation is temporarily stopped. As switches for controlling the power supply, switches composed of semiconductor devices referred to as IPDs (Intelligent Power Devices) are used, for example.

In the system configuration described above, it is conceivable to enable the on/off control of the IPD by an ECU different from the ECU that normally controls the on/off state of the IPD, for the purpose of improving the redundancy of control. Even in such cases, there may be situations where it may be desirable to eliminate control redundancy in each ECU.

The present disclosure provides a power control system for electronic control units, in which an electronic control unit that controls a semiconductor switch can, as necessary, eliminate redundant control by other devices.

According to one aspect of the present disclosure, a power control system for an electronic control unit, mounted on a mobile body, the power control system includes a plurality of electronic control devices configured to receive power from a battery. At least one of the plurality of electronic control devices corresponds to a switch control device that controls on/off state of a semiconductor switch for supplying the power from the battery to other electronic control devices. The switch control device includes a control logic that enables redundant control of the semiconductor switch by designating one of the other electronic control devices as a redundant control device, and also allows invalidation of the redundant control.

With this configuration, the switch control device can, as necessary, select to enable redundant control of the semiconductor switch by other devices or to eliminate redundant control.

### First Embodiment

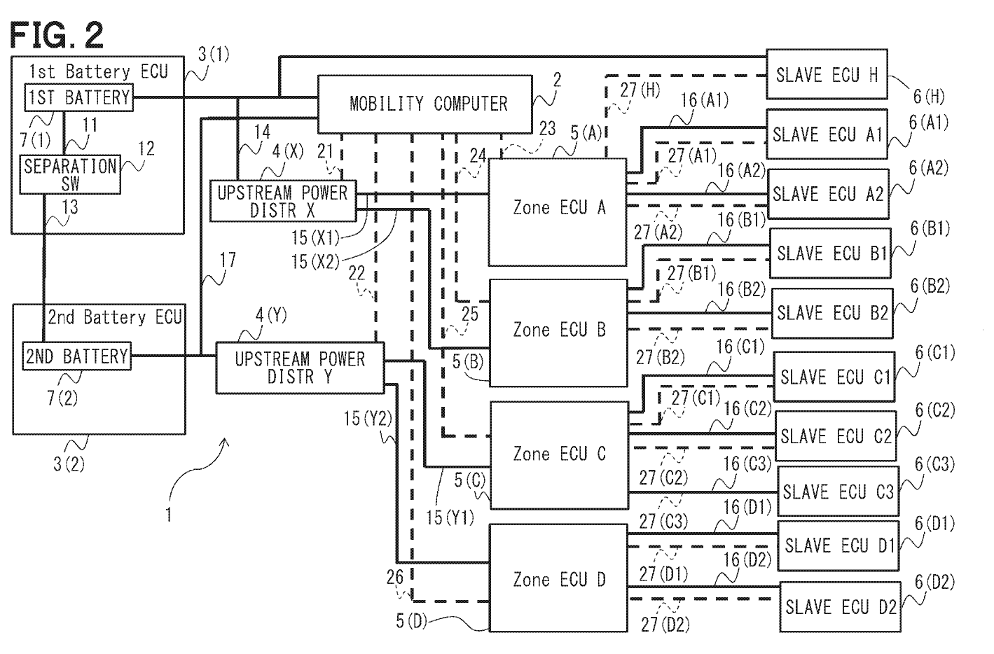

The power control system 1 of the present embodiment is based on a zone architecture and is configured to include a plurality of ECUs arranged according to zones, which indicate installation regions such as the front, rear, left, and right of the vehicle body. As shown in FIG. 2, the power control system 1, which is mounted on a vehicle corresponding to a mobile body or a mobile object, includes a mobility computer (may also be referred to as “mobicon") 2, first and second battery ECUs 3(1) and 3(2), upstream power distribution units 4(X) and 4(Y), zone ECUs 5(A) to 5(D), and slave ECUs 6(A1), 6(A2) to 6(H).

The first battery ECU 3(1) is provided with a first battery 7(1), and the second battery ECU 3(2) is provided with a second battery 7(2). Between the first battery 7(1) and the second battery 7(2), a power line 11, an isolation switch 12, and a power line 13 are connected. The isolation switch 12 is disposed on the side of the first battery ECU 3(1) and is normally turned on. For example, if a failure occurs on the side of the second battery 7(2), the isolation switch 12 is turned off by the first battery ECU 3(1). The on/off state of the isolation switch 12 is controlled by a control unit (not shown) constituting the first battery ECU 3(1). It should be noted that the first battery ECU 3(1) and the second battery ECU 3(2) themselves also operate by receiving power supply from the first battery 7(1) and the second battery 7(2), respectively.

The first battery 7(1), the mobility computer 2, the upstream power distribution unit 4(X), and the slave ECU 6(H) are connected so as to be capable of power distribution via a power line 14. The upstream power distribution unit 4(X) and the zone ECU 5(A) are connected so as to be capable of power distribution via a power line 15(X1), and the upstream power distribution unit 4(X) and the zone ECU 5(B) are connected so as to be capable of power distribution via a power line 15(X2).

The zone ECU 5(A) and the slave ECU 6(A1) are connected so as to be capable of power distribution via a power line 16(A1), and the zone ECU 5(A) and the slave ECU 6(A2) are connected so as to be capable of power distribution via a power line 16(A2). The zone ECU 5(B) and the slave ECU 6(B1) are connected so as to be capable of power distribution via a power line 16(B1), and the zone ECU 5(B) and the slave ECU 6(B2) are connected so as to be capable of power distribution via a power line 16(B2).

The second battery 7(2), the mobility computer 2, and the upstream power distribution unit 4(Y) are connected so as to be capable of power distribution via a power line 17. The upstream power distribution unit 4(Y) and the zone ECU 5(C) are connected so as to be capable of power distribution via a power line 15(Y1), and the upstream power distribution unit 4(Y) and the zone ECU 5(D) are connected so as to be capable of power distribution via a power line 15(Y2).

The zone ECU 5(C) and the slave ECU 6(C1) are connected so as to be capable of power distribution via a power line 16(C1), and the zone ECU 5(C) and the slave ECU 6(C2) are connected so as to be capable of power distribution via a power line 16(C2). The zone ECU 5(C) and the slave ECU 6(C3) are connected so as to be capable of power distribution via a power line 16(C3). The zone ECU 5(D) and the slave ECU 6(D1) are connected so as to be capable of power distribution via a power line 16(D1), and the zone ECU 5(D) and the slave ECU 6(D2) are connected so as to be capable of power distribution via a power line 16(D2).

The mobility computer 2 and the upstream power distribution unit 4(X) are connected so as to be capable of communication via a communication line 21, and the mobility computer 2 and the upstream power distribution unit 4(Y) are connected so as to be capable of communication via a communication line 22. The mobility computer 2 and the zone ECU 5(A) are connected so as to be capable of communication via a communication line 23. The mobility computer 2 and the zone ECU 5(B) are connected so as to be capable of communication via a communication line 24. The mobility computer 2 and the zone ECU 5(C) are connected so as to be capable of communication via a communication line 25. The mobility computer 2 and the zone ECU 5(D) are connected so as to be capable of communication via a communication line 26.

The zone ECU 5(A) and the slave ECU 6(A1) are connected so as to be capable of communication via a communication line 27(A1), and the zone ECU 5(A) and the slave ECU 6(A2) are connected so as to be capable of communication via a communication line 27(A2). The zone ECU 5(A) and the slave ECU 6(H) are connected so as to be capable of communication via a communication line 27(H). The zone ECU 5(B) and the slave ECU 6(B1) are connected so as to be capable of communication via a communication line 27(B1), and the zone ECU 5(B) and the slave ECU 6(B2) are connected so as to be capable of communication via a communication line 27(B2).

The zone ECU 5(C) and the slave ECU 6(C1) are connected so as to be capable of communication via a communication line 27(C1), and the zone ECU 5(C) and the slave ECU 6(C2) are connected so as to be capable of communication via a communication line 27(C2). The zone ECU 5(C) and the slave ECU 6(C3) are connected so as to be capable of communication via a communication line 27(C3). The zone ECU 5(D) and the slave ECU 6(D1) are connected so as to be capable of communication via a communication line 27(D1), and the zone ECU 5(D) and the slave ECU 6(D2) are connected so as to be capable of communication via a communication line 27(D2). Each of these communication lines is a communication line capable of communication based on a communication frame conforming to, for example, the CAN (Controller Area Network; registered trademark) or CAN FD (CAN With Flexible Data Rate; registered trademark) communication protocols.

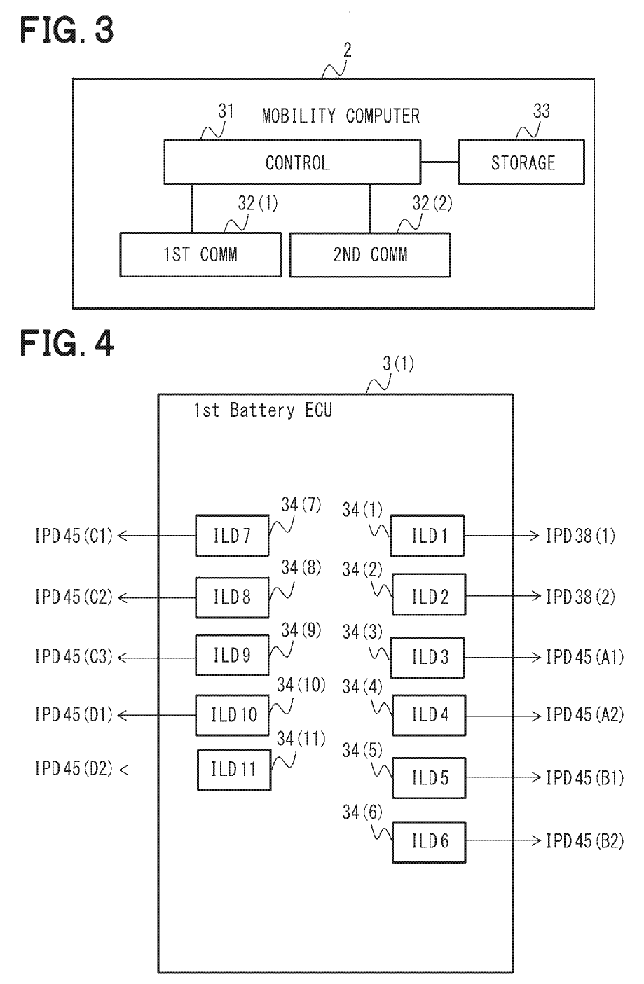

FIG. 3 is a functional block diagram showing the internal configuration of the mobility computer 2. The mobility computer 2 is provided with a mobility computer control unit 31 composed of a microcomputer, a first mobility computer communication unit 32(1) and a second mobility computer communication unit 32(2), and a mobility computer storage unit 33. The mobility computer 2 is a control device capable of controlling the operation of the battery ECU 3, the upstream power distribution unit 4, the zone ECU 5, and the slave ECU 6. For example, the first mobility computer communication unit 32(1) controls data communication with the upstream power distribution unit 4(X) via the communication line 21, data communication with the zone ECU 5(A) via the communication line 23, and data communication with the zone ECU 5(B) via the communication line 24.

The second mobility computer communication unit 32(2) controls data communication with the upstream power distribution unit 4(Y) via the communication line 22, data communication with the zone ECU 5(C) via the communication line 25, and data communication with the zone ECU 5(D) via the communication line 26. The mobility computer storage unit 33 is, for example, a non-volatile memory, such as a rewritable flash memory or EEPROM, for storing various types of data.

FIG. 4 is a functional block diagram showing the internal configuration of the first battery ECU 3(1), with components shown in FIG. 2 omitted. The first battery ECU 3(1) is provided with interlock drivers (referred to as "IDL") 34(1) to 34(11). These IDL 34 output signals for controlling the on/off state of semiconductor power switches, such as power MOSFETs, which are incorporated in the IPD 38 provided in the upstream power distribution unit 4 and the IPD 45 provided in the zone ECU 5, as described later.

The IDL 34 of the present embodiment is configured, for example, as an intelligent driver incorporating a control unit similar to the mobility computer control unit 31, and this control unit performs the aforementioned control. However, the configuration is not limited to this; the IDL 34 may be composed only of a drive circuit, with control signals input from a separately configured control unit, or control signals may be input by the control unit constituting the first battery ECU 3(1).

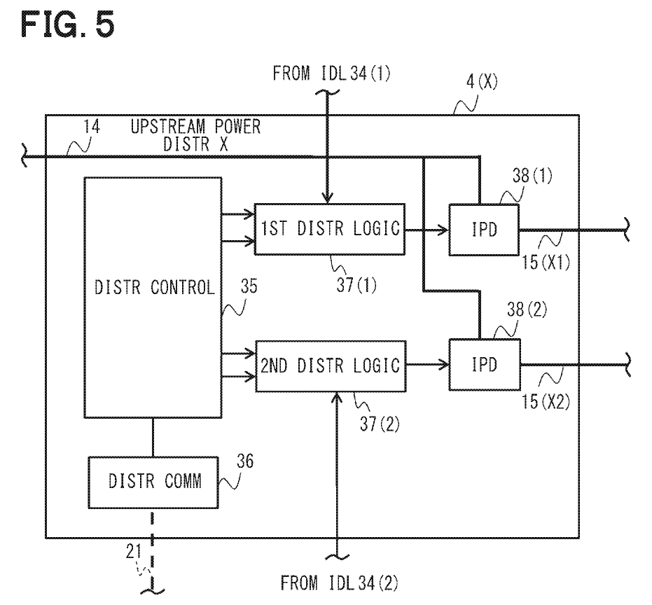

FIG. 5 is a functional block diagram showing the internal configuration of the upstream power distribution unit 4(X). The upstream power distribution unit 4(X) is provided with a distribution control unit 35 composed of a microcomputer, a distribution communication unit 36, a first distribution logic unit 37(1) and a second distribution logic unit 37(2), as well as IPD (Intelligent Power Device) 38(1) and 38(2). The IPD 38 incorporates a protection circuit and is equipped with a high-performance semiconductor power switch and protection circuit capable of absorbing energy from inductive loads and the like.

The IPD may also be referred to as a semiconductor fuse, IPS (Intelligent Power Switch), smart switch, high-side/low-side switch, etc. Compared to mechanical relays with mechanical contacts, the IPD, which does not have mechanical contacts, offers superior mechanical durability and quietness, as well as the advantage of a compact size. In addition, since it is equipped with protection functions not present in mechanical relays, high reliability can also be ensured.

The distribution control unit 35 outputs signals for controlling the on/off state of the semiconductor power switches incorporated in the IPD 38 via the distribution logic unit 37 corresponding to the control logic. By means of IPD 38(1) and 38(2), the power supply state to the downstream-connected zone ECUs 5(A) and 5(B) is controlled. When the semiconductor power switch is turned on, power is supplied to the zone ECU 5; when the semiconductor power switch is turned off, power supply to the zone ECU 5 is inhibited.

To the first distribution logic unit 37(1), an interlock control signal, which is a redundant control signal, is input from the IDL 34(1) provided in the first battery ECU 3(1). To the second distribution logic unit 37(2), an interlock control signal from the IDL 34(2) is input. The distribution control unit 35 also inputs a signal to the distribution logic unit 37 for invalidating the interlock control signal. Details of the distribution logic unit 37 will be described later. The internal configuration of the upstream power distribution unit 4(Y) is the same as that of the upstream power distribution unit 4(X). Furthermore, the upstream power distribution unit 4 is also an electronic control unit.

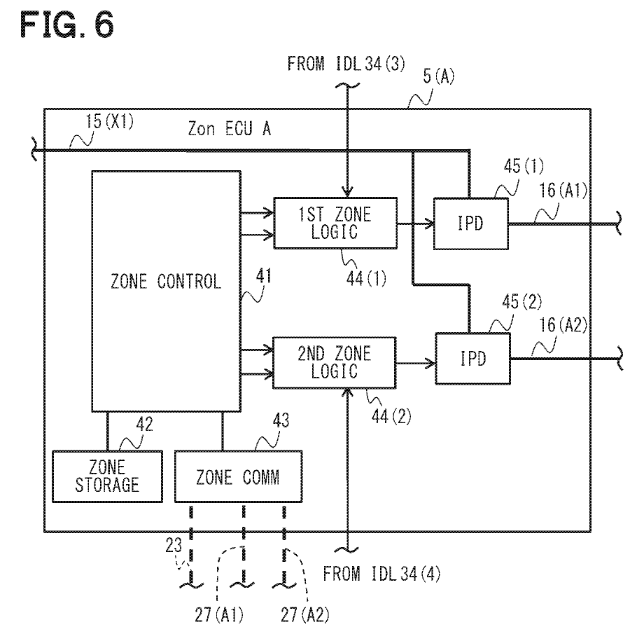

FIG. 6 is a functional block diagram showing the internal configuration of the zone ECU 5(A). The zone ECU 5(A) is provided with a zone control unit 41 composed of a microcomputer, a zone storage unit 42, a zone communication unit 43, a first zone logic unit 44(1) and a second zone logic unit 44(2), as well as IPD 45(1) and 45(2). The zone control unit 41, similar to the upstream power distribution unit 4(X), outputs signals for controlling the on/off state of the semiconductor power switches incorporated in the IPD 45 via the zone logic unit 44 corresponding to the control logic. By means of IPD 45, the power supply state to the downstream-connected slave ECUs 6(A1) and 6(A2) is controlled.

To the first zone logic unit 44(1), an interlock control signal from IDL 34(3) provided in the first battery ECU 3(1) is input, and to the second zone logic unit 44(2), an interlock control signal from IDL 34(4) is input. The zone control unit 41 also inputs a signal for invalidating the interlock control signal to the first zone logic unit 44(1) and the second zone logic unit 44(2). The configuration of the zone logic unit 44 is the same as that of the distribution logic unit 37. The interlock control signal may be referred to as the IDL control signal. The internal configuration of the zone ECUs 5(B) to 5(D) is basically the same as that of the zone ECU 5(A), but the zone ECU 5(C) is provided with three sets of zone logic units 44 and IPDs 45.

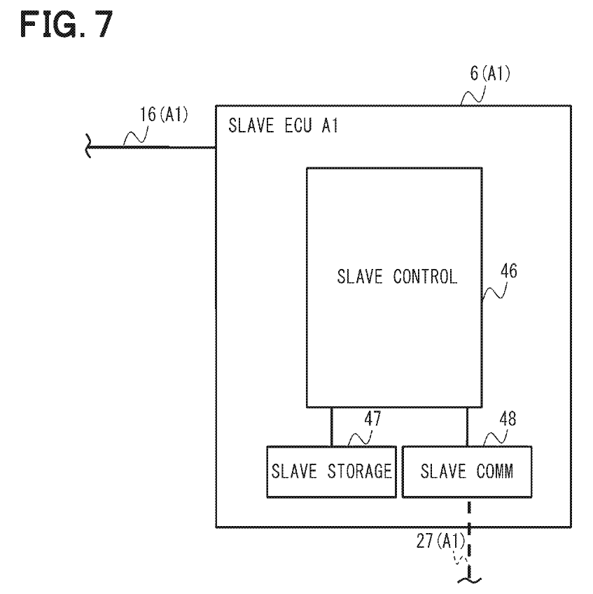

FIG. 7 is a functional block diagram showing the internal configuration of the slave ECU 6(A1). The slave ECU 6(A1) is provided with a slave control unit 46 composed of a microcomputer, a slave storage unit 47, and a slave communication unit 48. The slave ECU 6 may be, for example, an engine control ECU, body ECU, air conditioner ECU, door ECU, security system ECU, safety system ECU, etc. The slave ECUs 6(A) to 6(D) connected downstream of each zone ECU 5(A) to 5(D) are classified as zones A to D for each region in which each slave ECU 6 is installed within the vehicle, such as the front, rear, left side, and right side.

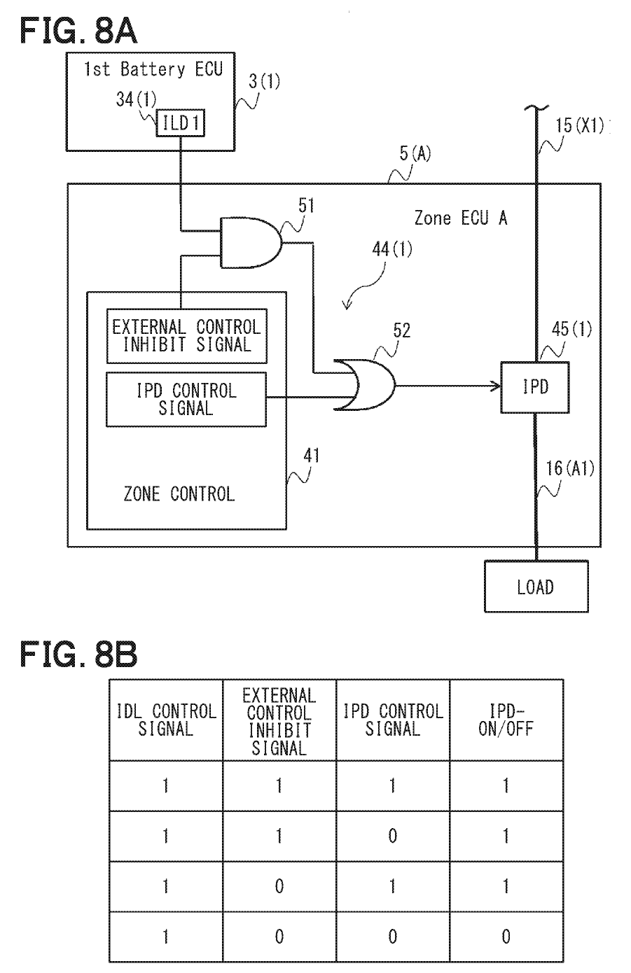

FIG. 8A shows, using zone ECU 5(A) as an example, the specific configuration of the first zone logic unit 44(1). The first zone logic unit 44(1) is composed of a combination of an AND gate 51 and an OR gate 52. To one input terminal of the AND gate 51, an IDL control signal, which is a redundant control signal output from IDL 34(1) mounted in the first battery ECU 3(1), is input. To the other input terminal of the AND gate 51, an external control inhibit signal output from the zone control unit 41 is input. To one input terminal of the OR gate 52, an IPL control signal output from the zone control unit 41 is input. The other input terminal of the OR gate 52 is connected to the output terminal of the AND gate 51. The output terminal of the OR gate 52 is connected to the gate of the power switch incorporated in IPD 45(1).

FIG. 8B shows the truth table of the first zone logic unit 44. When the external control inhibit signal is "1," the IDL control signal becomes valid, and the on/off state of the semiconductor power switch in IPD 45(1) is controlled by the logical OR condition of the IPL control signal and the IDL control signal. When the external control inhibit signal is "0," the IDL control signal becomes invalid, and the on/off state of the semiconductor power switch in IPD 45(1) is controlled only by the IPL control signal. In this embodiment, the upstream power distribution unit 4(X) and the zone ECUs 5(A) to 5(D) correspond to the switch control device, and the first battery ECU 3(1) corresponds to the redundant control device. Note that the "load" shown in the figure corresponds to the downstream-connected zone ECU 5(A), but this is not limited thereto and may also be, for example, a drive circuit such as an inverter for driving a motor.

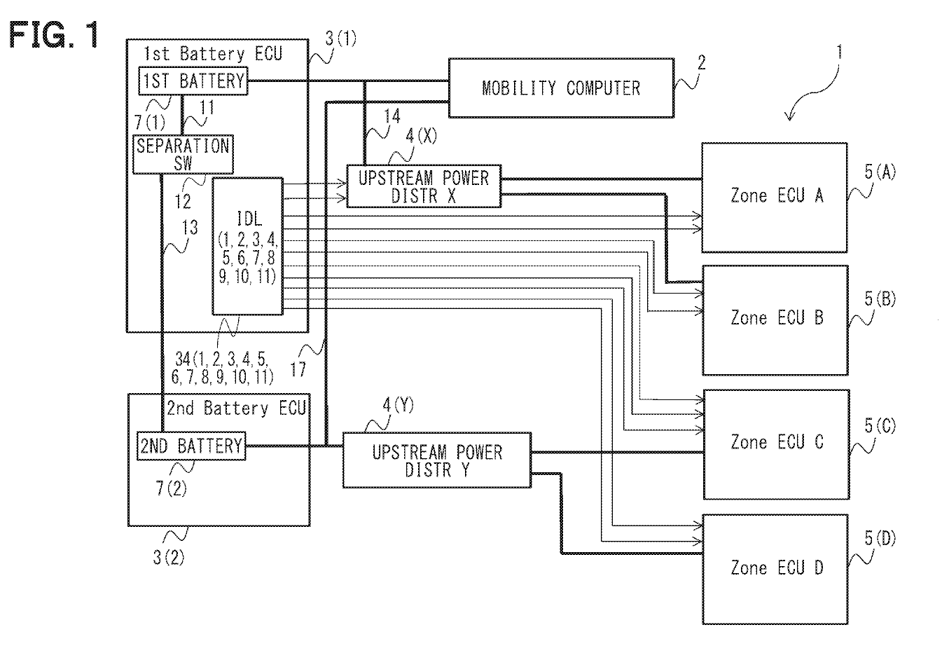

FIG. 1 mainly illustrates each IDL control signal output from IDL 34(1) to 34(11) mounted in the first battery ECU 3(1) to the upstream power distribution unit 4(X) and the zone ECUs 5(A) to 5(D). In this embodiment, the IDL 34(1) to 34(11) individually output IDL control signals to the upstream power distribution unit 4(X) and the zone ECUs 5(A) to 5(D), which are equipped with IPD 38 and 45, respectively. Each IDL 34 individually controls the on/off state of the semiconductor power switches provided in IPD 38 and 45 as necessary, based on vehicle information collected by itself or by the first battery ECU 3(1). The above control instructions may also be received from the mobility computer 2.

As described above, according to this embodiment, the power control system 1 is mounted on a vehicle and supplies power from the battery 7 to a plurality of ECUs 5(A) to 5(D) and 6(A) to 6(H) via the battery ECU 3 and the upstream power distribution unit 4. The upstream power distribution unit 4(X) and the zone ECUs 5(A) to 5(D) each control the on/off state of the semiconductor power switches in their respective IPD 38 or 45.

The distribution logic unit 37 provided in the upstream power distribution unit 4(X) and the zone logic unit 44 provided in the zone ECUs 5(A) to 5(D) are configured to enable redundant control of the semiconductor power switches by the first battery ECU 3(1), and to invalidate such redundant control. Accordingly, the upstream power distribution unit 4(X) and the zone ECUs 5(A) to 5(D) can, as necessary, select to enable redundant control of the semiconductor power switches by the first battery ECU 3(1) or to eliminate redundant control.

### Second Embodiment

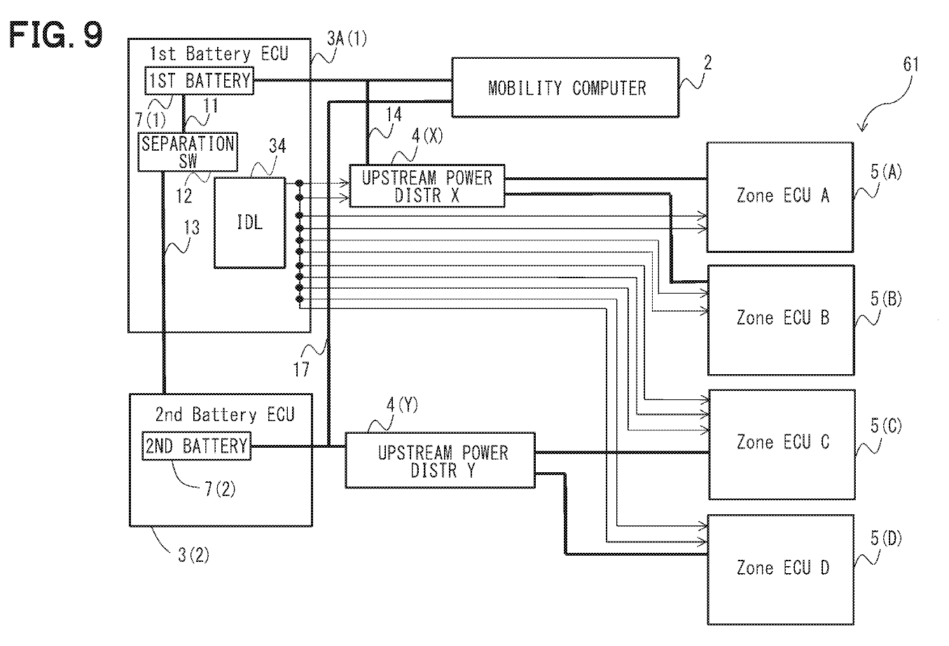

The same reference numerals are assigned to parts identical to those in the first embodiment, and explanations thereof are omitted; only the differences will be described. As shown in FIG. 9, in the power control system 61 of the second embodiment, only one IDL 34 is mounted in the first battery ECU 3A(1). The on/off state of the semiconductor power switches provided in each IPD 38, 45 of the upstream power distribution unit 4(X) and the zone ECUs 5(A) to 5(D) is collectively controlled by a common IDL control signal.

### Third Embodiment

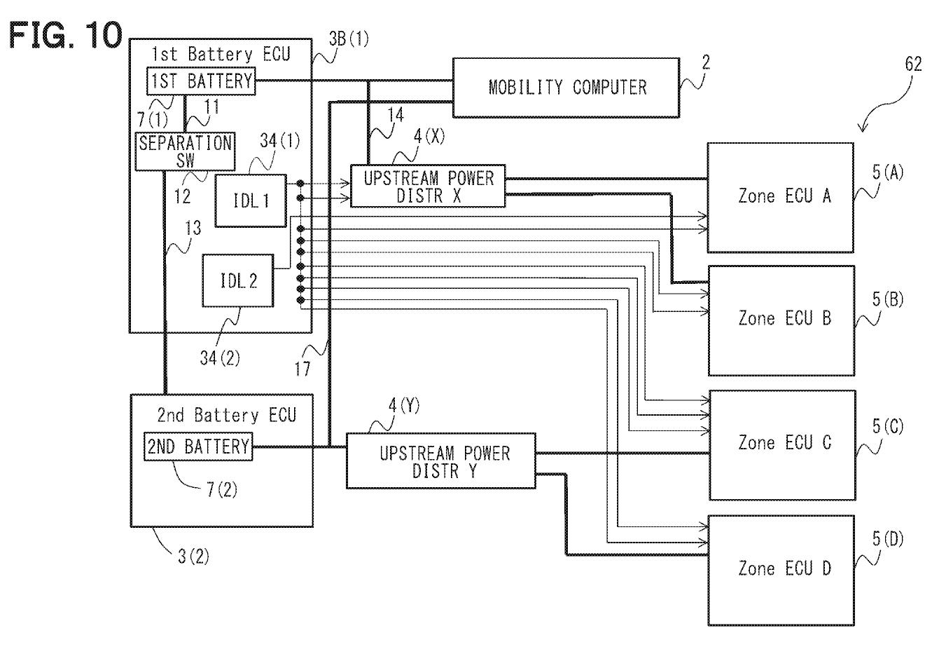

As shown in FIG. 10, in the power control system 62 of the third embodiment, two IDLs 34(1) and 34(2) are mounted in the first battery ECU 3(1). The IDL 34(2) outputs the IDL control signal only to the first zone logic unit 44(1) provided in the zone ECU 5(A). To the other logic units 37 and 44, the IDL 34(1) outputs the IDL control signal collectively.

In this case, only the power supply to the slave ECU 6(A), which is connected via the power line 16(A1) to the IPD 38(1) provided in the zone ECU 5(A), is redundantly controlled by the IDL 34(2). As the slave ECU 6(A), for example, a device that is supplied with power by the on/off operation of an accessory switch or ignition switch, which rarely operates by distinguishing the power-on state in the vehicle, may be selected. Note that the IDL 34(2) may also be mounted in the second battery ECU 3(2).

### Fourth Embodiment

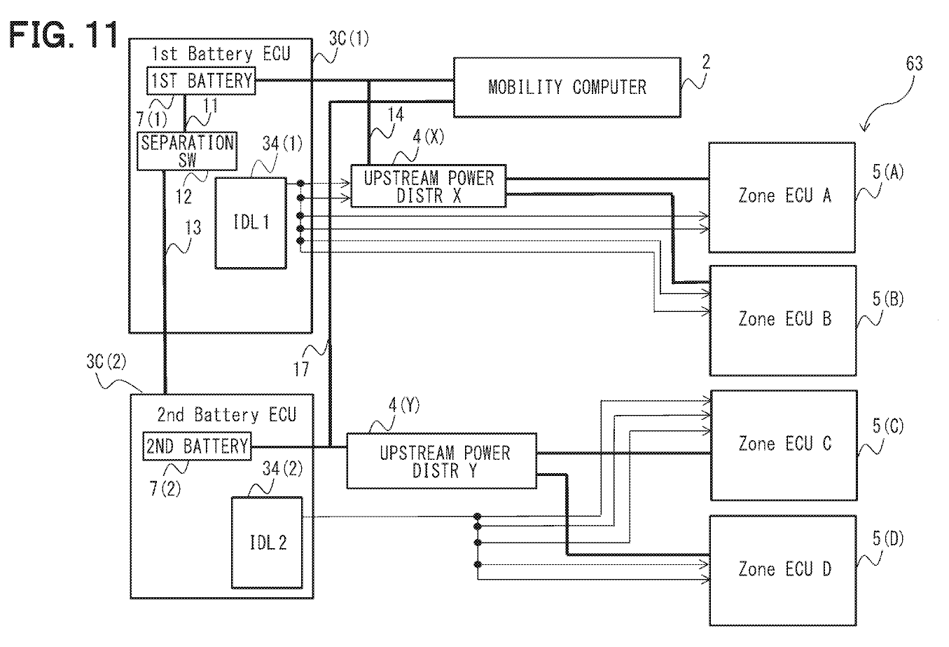

As shown in FIG. 11, in the power control system 63 of the fourth embodiment, IDL 34(1) is mounted in the first battery ECU 3C(1), and IDL 34(2) is mounted in the second battery ECU 3C(2). The IDL 34(1) collectively outputs the IDL control signal to the upstream power distribution unit 4(X) as well as to the zone ECUs 5(A) and 5(B). The IDL 34(2) collectively outputs the IDL control signal to the zone ECUs 5(C) and 5(D). That is, the two IDLs 34(1) and 34(2) are configured to collectively output IDL control signals separately to the upstream power distribution unit 4(X) side and the upstream power distribution unit 4(Y) side, each corresponding to a different power supply system.

### Fifth Embodiment

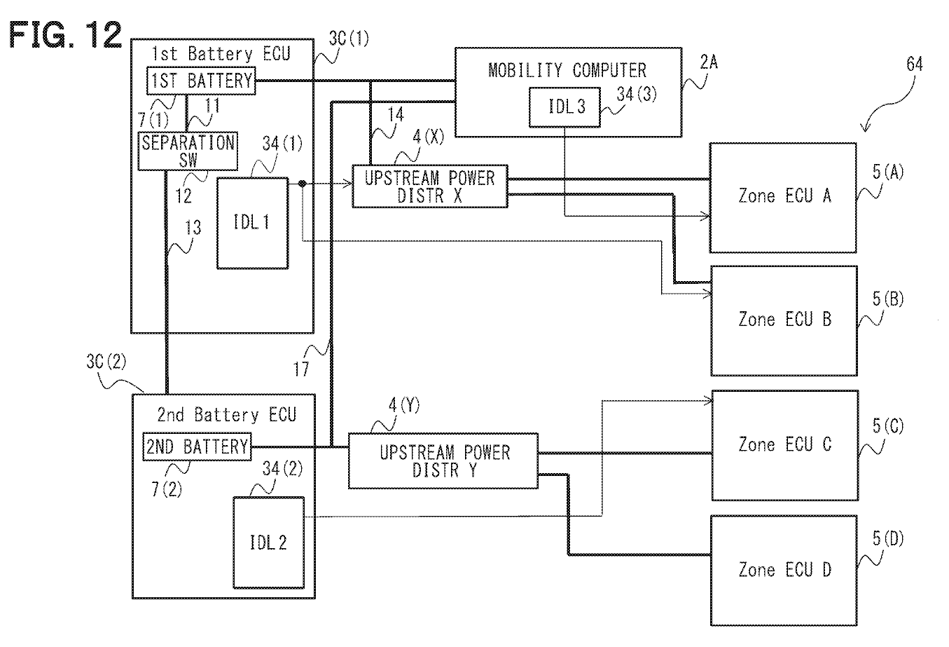

As shown in FIG. 12, in the power control system 64 of the fifth embodiment, in addition to the configuration of the fourth embodiment, IDL 34(3) is mounted in the mobility computer 2A. The IDL 34(3) outputs an IDL control signal to the first zone logic unit 44(1) of the zone ECU 5(A). The IDL 34(1) outputs an IDL control signal to the first distribution logic unit 37(1) of the upstream power distribution unit 4(X) and to the first zone logic unit 44(1) of the zone ECU 5(B). The IDL 34(2) outputs an IDL control signal to the first zone logic unit 44(1) of the zone ECU 5(C).

Thus, in the fifth embodiment, the three IDLs 34(3), 34(1), and 34(2) are configured to individually output IDL control signals to the zone ECUs 5(A), 5(B), and 5(C), respectively. This configuration corresponds to cases in the zone architecture where it is desired to individually control power supply for each zone.

### Sixth Embodiment

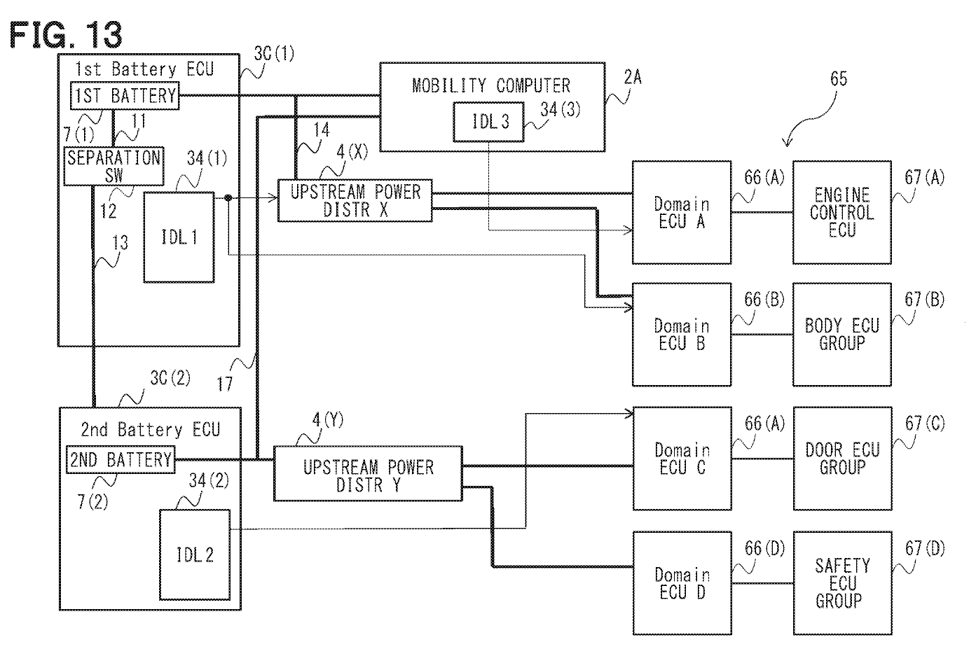

As shown in FIG. 13, in the power control system 65 of the sixth embodiment, instead of the zone ECUs 5(A) to 5(D) in the configuration of the fifth embodiment, domain ECUs 66(A) to 66(D) are arranged, illustrating the case of application to a domain architecture. Each domain ECU 66(A) to 66(D) is connected to a respective slave ECU 67(A) to 67(D). For example, the slave ECU 67(A) is an engine control ECU, the slave ECU 67(B) is a group of body ECUs, the slave ECU 67(C) is a group of door ECUs, and the slave ECU 67(D) is a group of safety ECUs.

As examples of the body ECU group, there are ECUs that control external lighting, interior lighting, wiper systems, and the like. As examples of the door ECU group, there are ECUs that control central door locking, power windows, electric door mirrors, and the like. As examples of the safety ECU group, there are ECUs that control airbags, occupant detection systems, automatic emergency notification devices for accidents, drive recorders, and the like. The domain ECUs 66(A) to 66(D) are classified according to the functional grouping of each slave ECU 67(A) to 67(D), such as engine control, body control, door control, and safety system control. In other words, the configuration corresponding to the zone architecture in the fifth embodiment is replaced with a domain architecture in this embodiment.

### Seventh Embodiment

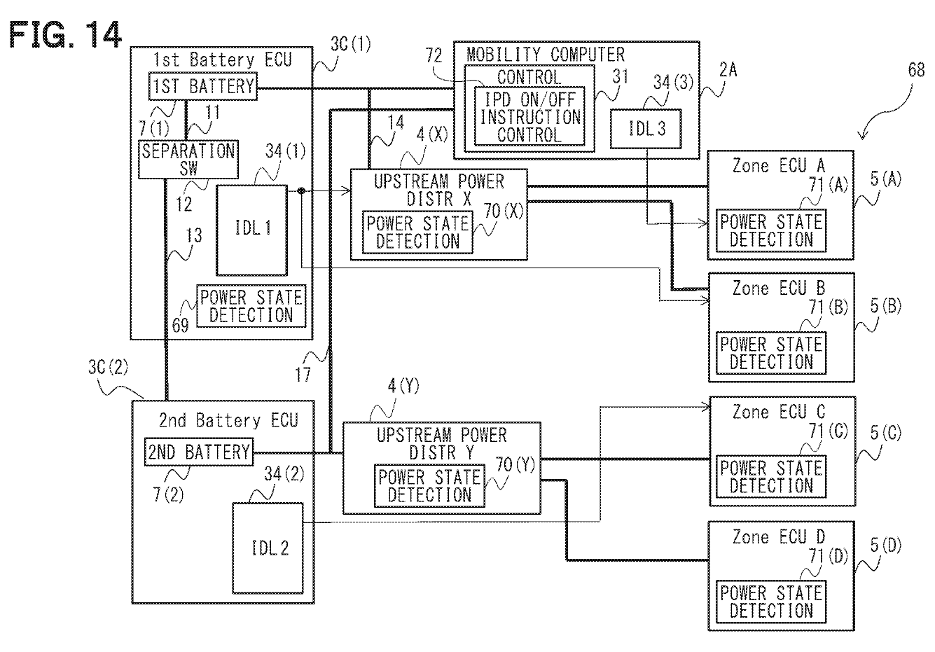

As shown in FIG. 14, the power control system 68 of the seventh embodiment illustrates a specific example of controlling the on/off state of IPD 38 or 45, for example, in the configuration of the fifth embodiment. Power state detection units 69 to 71 are arranged in the first battery ECU 3(1), the upstream power distribution unit 4, and the zone ECUs 5(A) to 5(D), respectively. The mobility computer control unit 31 of the mobility computer 2A includes, as a subordinate functional block, an IPD on/off instruction control unit 72. An outline of the processing flow is described below.

It is assumed that the power control function within the mobility computer 2A manages and operates the overall on/off state of IPD 38 and 45.

The mobility computer 2A collects detection information from each power state detection unit 69 to 71 via communication lines 21 to 26 or via direct signal lines (not shown).

Applications governing normal vehicle operation change the power state of ECUs other than the mobility computer 2A and the on/off state of IPD 38 and 45 through the above-mentioned power control function.

Therefore, when turning on IPD 38 and 45 to which the IDL control signal is input, the IPD on/off instruction control unit 72 of the mobility computer 2A transmits signals instructing the on/off state of the semiconductor power switches to both the first battery ECU 3(1) equipped with IPD 38 and the zone ECU 5 equipped with IPD 45.

When a common IDL control signal is output to the upstream power distribution unit 4(X) and the zone ECU 5(B), the on/off switching of the semiconductor power switches in each IPD 38 and 45 occurs at the same timing.

### Eighth Embodiment

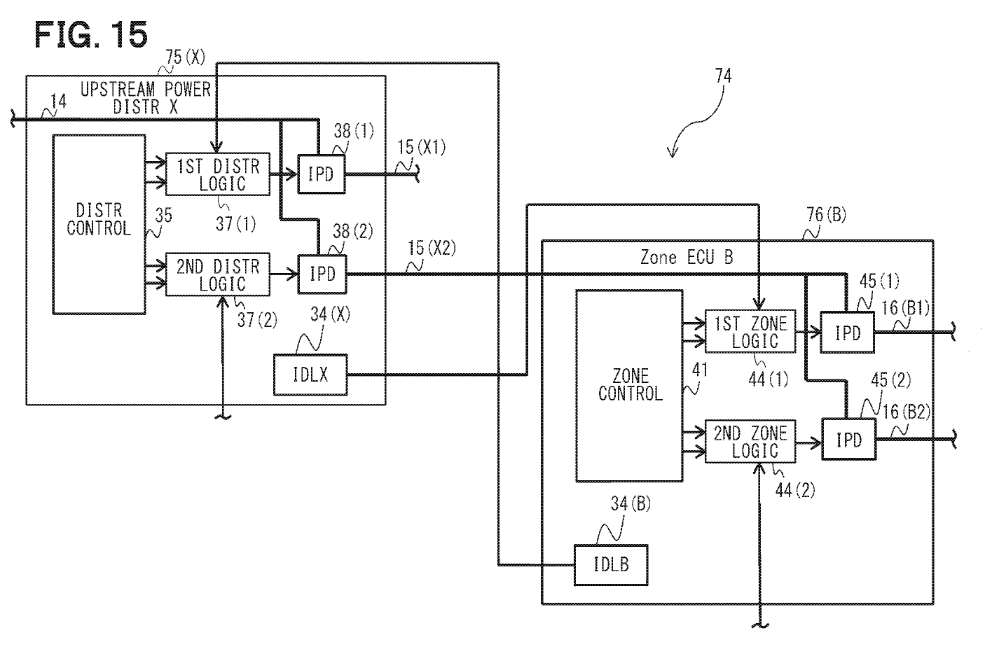

As shown in FIG. 15, the power control system 74 of the eighth embodiment illustrates control performed between the upstream power distribution unit 75(X) and the zone ECU 76(B). The upstream power distribution unit 75(X) is equipped with IDL 34(X), and the zone ECU 76(B) is equipped with IDL 34(B). The IDL 34(X) outputs an IDL control signal to the first zone logic unit 44(1) of the zone ECU 76(B), and the IDL 34(B) outputs an IDL control signal to the first distribution logic unit 37(1) of the upstream power distribution unit 75(X). As a result, interlock control is mutually performed between the upstream power distribution unit 75(X) and the zone ECU 76(B).

That is, if the zone ECU 76(B) is considered as the switch control device, the upstream power distribution unit 75(X) becomes the redundant control device. Conversely, if the upstream power distribution unit 75(X) is considered as the switch control device, the zone ECU 76(B) becomes the redundant control device.

### Other Embodiments

The battery ECU 3 and battery 7 may be one or three or more. The upstream power distribution unit 4 may be three or more, or may be omitted if distribution is not necessary.

The numbers of zone ECUs 5, slave ECUs 6, and domain ECUs 66 may be changed as appropriate.

In the third embodiment, the IDL control signal output by IDL 34(2) may be output to two or more zone logic units 44.

When communication between the mobility computer 2 and the zone ECUs 5(A) to 5(D), or between the zone ECUs 5(A) to 5(D) and the slave ECUs 6(A) to 6(D), is performed using the Ethernet (registered trademark) protocol, part of the communication lines may be consolidated by using an Ethernet switch or the like.

The division of zones is not limited to front, rear, left side, and right side. Also, the division of domains is not limited to those shown in the sixth embodiment.

In the eighth embodiment, the devices that mutually perform interlock control are not limited to between the upstream power distribution unit 75(X) and the zone ECU 76(B).

The mobile body is not limited to a vehicle, but may also be an aircraft, ship, or the like.

This disclosure has been described in accordance with the embodiments, but it is understood that the disclosure is not limited to the embodiments or structures described herein. The disclosure also encompasses various modifications and equivalents within the scope of the disclosure. Furthermore, various combinations and forms, as well as other combinations and forms including only one element, more than one, or fewer, are also within the scope and spirit of this disclosure.

What is claimed is:

1. A power control system for an electronic control unit, mounted on a mobile body, the power control system comprising:
a plurality of electronic control devices configured to receive power from a battery,
wherein
at least one of the plurality of electronic control devices is a switch control device that controls an on/off state of a semiconductor switch for supplying power from the battery to other electronic control devices; and
the switch control device includes a control logic that enables redundant control of the semiconductor switch by designating one of the other electronic control devices as a redundant control device, and also allows invalidation of the redundant control.

2. The power control system according to claim 1, wherein
a plurality of switch control devices are provided, and
the redundant control device performs redundant control for each of the other switch control devices.

3. The power control system according to claim 1, wherein
a plurality of switch control devices are provided, and
the redundant control device collectively performs redundant control for all of the other switch control devices.

4. The power control system according to claim 1, wherein
a plurality of switch control devices are provided, and
when power is supplied to the plurality of switch control devices via a plurality of power supply systems, a plurality of redundant control devices are provided, each corresponding to one of the plurality of power supply systems.

5. The power control system according to claim 4, wherein
the plurality of power supply systems are divided in correspondence with a plurality of installation regions within the mobile body, and
the plurality of electronic control devices are respectively disposed in the plurality of installation regions.

6. The power control system according to claim 4, wherein
the plurality of power supply systems are divided in correspondence with a plurality of functions within the mobile body, and
the plurality of electronic control devices are respectively assigned to the plurality of functions.

7. The power control system according to claim 1, wherein
at least two of switch control devices are configured to serve as redundant control devices for each other, and are arranged to mutually perform redundant control of the semiconductor switch of each other.

8. The power control system according to claim 1, wherein
the control logic includes:
an AND gate configured to perform a logical AND between a redundant control signal output from the redundant control device and a signal output from the switch control device for disabling control from the redundant control device; and
an OR gate configured to perform a logical OR between an output signal of the AND gate and a control signal for the semiconductor switch output from the switch control device.
